(19) United States
(12) Patent Application Publication
(10) Pub. No.: US 2010/0208700 A1
(43) Pub. Date: Aug. 19, 2010

(54) METHODS AND SYSTEMS FOR SELECTING A HANDOVER BASE STATION IN MOBILE WIMAX

(75) Inventors: Guangming Carl Shi, San Diego, CA (US); Tom Chin, San Diego, CA (US); Kuo-Chun Lee, San Diego, CA (US); Wei Zhang, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/703,153

(22) Filed: Feb. 9, 2010

Related U.S. Application Data
(60) Provisional application No. 61/152,457, filed on Feb. 13, 2009.

(51) Int. Cl. H04W 36/00

(52) U.S. Cl. 370/331

(57) ABSTRACT

Methods and apparatus for improving performance and robustness of a handover procedure. For example, by handing over to a target base station (BS) that is co-located with a serving BS (i.e., a BS located in the same physical node as the serving BS), mobile station (MS) context transfers, handover preparation and downlink (DL) data continuity between the serving BS and the target BS may be simplified because the serving BS and the target BS are in the same physical node. Further, a location-based services advertisement (LBS-ADV) message may be enhanced to include sector center directions of the serving BS and neighboring BSs. Using this information, an MS may determine neighboring BSs that are adjacent to the serving BS and limit scanning operations and handovers to these adjacent BSs, thereby reducing the processing for those operations.

### CLAIM OF PRIORITY

This application claims the benefit of priority from U.S. Provisional Patent Application Ser. No. 61/152,457, entitled “Methods and Systems for Selecting a Co-Located or Adjacent Base Station in Mobile WiMAX Handover” and filed Feb. 13, 2009, which is assigned to the assignee of this application and is fully incorporated herein by reference for all purposes.

### TECHNICAL FIELD

Certain embodiments of the present disclosure generally relate to wireless communications and more particularly, for selecting at least one co-located or adjacent base station in a mobile WiMAX handover.

### BACKGROUND

A wireless communication system may provide communication for a number of cells, each of which may be serviced by a base station (BS). A cell may be divided into multiple sectors. A sector is a physical coverage area within a cell. When there are multiple sectors per cell and a mobile station (MS) performs a handover to a target BS of the same cell, it is referred to as an intra-cell handover. Otherwise, if an MS performs a handover to a target BS of a different cell, it is referred to as an inter-cell handover. When an MS performs an intra-cell handover, MS context transfers, handover preparation and downlink (DL) data continuity between the serving BS and the target BS may be simplified because the serving BS and the target BS are in the same physical node.

When performing a handover in mobile Worldwide Interoperability for Microwave Access (WiMAX), a mobile station (MS) may determine the target base station (BS). Current WiMAX standards provide some background information of the possible neighbor BSs, including handover process optimization, the scheduling service(s) supported, the handover authorization policy supported, etc. This information may be transmitted to an MS in a mobile neighbor advertisement (MOB_NBR-ADV) message or a mobile base station handover request/response (MOB_BSHO-RSP/REQ). However, the information transmitted to an MS in an MOB_NBR-ADV or an MOB_BSHO-RSP/REQ does not distinguish between intra-cell and inter-cell handovers, which may reduce handover performance and robustness.

### SUMMARY

Certain embodiments provide a method for wireless communications. The method generally includes identifying a neighboring base station co-located with a serving base station based on location information regarding a location of the serving base station and at least one neighboring base station, wherein the neighboring base station is co-located with the serving base station when the base stations are in a same cell, and transmitting a request to handover from the serving base station to the co-located base station.

Certain embodiments provide a method for wireless communications. The method generally includes receiving a sector direction of a serving base station and one or more sector direction of one or more neighboring base stations, identifying a subset of the one or more neighboring base stations that are adjacent to the serving base station based on, at least in part, the sector direction of the serving base station and the one or more sector directions of the one or more neighboring base stations, and transmitting a request to handover from the serving base station to one of the subset of the one or more neighboring base stations.

Certain embodiments provide a method for wireless communications. The method generally includes transmitting a sector direction of a serving base station and one or more sector directions of one or more neighboring base stations, and receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

Certain embodiments provide an apparatus for wireless communications. The apparatus generally includes logic for identifying a neighboring base station co-located with a serving base station based on location information regarding a location of the serving base station and at least one neighboring base station, wherein the neighboring base station is co-located with the serving base station when the base stations are in a same cell, and logic for transmitting a request to handover from the serving base station to the co-located base station.

Certain embodiments provide an apparatus for wireless communications. The apparatus generally includes logic for receiving a sector direction of a serving base station and one or more sector directions of one or more neighboring base stations, logic for identifying a subset of the one or more neighboring base stations that are adjacent to the serving base station based on, at least in part, the sector direction of the serving base station and the one or more sector directions of the one or more neighboring base stations, and logic for transmitting a request to handover from the serving base station to one of the subset of the one or more neighboring base stations.

Certain embodiments provide an apparatus for wireless communications. The apparatus generally includes logic for transmitting a sector direction of a serving base station and one or more sector directions of one or more neighboring base stations, and logic for receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

Certain embodiments provide an apparatus for wireless communications. The apparatus generally includes means for identifying a neighboring base station co-located with a serving base station based on location information regarding a location of the serving base station and at least one neighboring base station, wherein the neighboring base station is co-located with the serving base station when the base stations are in a same cell, and means for transmitting a request to handover from the serving base station to the co-located base station.

Certain embodiments provide an apparatus for wireless communications. The apparatus generally includes means for receiving a sector direction of a serving base station and one or more sector directions of one or more neighboring base stations, means for identifying a subset of the one or more neighboring base stations that are adjacent to the serving base station based on, at least in part, the sector direction of the serving base station and the one or more sector directions of the one or more neighboring base stations, and means for transmitting a request to handover from the serving base station to one of the subset of the one or more neighboring base stations.

Certain embodiments provide an apparatus for wireless communications. The apparatus generally includes means for transmitting a sector direction of a serving base station and one or more sector directions of one or more neighboring base stations, and means for receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

Certain embodiments provide a computer-program storage apparatus for wireless communications comprising a memory device having a set of instructions stored thereon, the set of instructions being executable by one or more processors. The set of instructions generally includes instructions for identifying a neighboring base station co-located with a serving base station based on location information regarding a location of the serving base station and at least one neighboring base station, wherein the neighboring base station is co-located with the serving base station when the base stations are in a same cell, and instructions for transmitting a request to handover from the serving base station to the co-located base station.

Certain embodiments provide a computer-program storage apparatus for wireless communications comprising a memory device having a set of instructions stored thereon, the set of instructions being executable by one or more processors. The set of instructions generally includes instructions for receiving a sector direction of a serving base station and one or more sector directions of one or more neighboring base stations, instructions for identifying a subset of the one or more neighboring base stations that are adjacent to the serving base station based on, at least in part, the sector direction of the serving base station and the one or more sector directions of the one or more neighboring base stations, and instructions for transmitting a request to handover from the serving base station to one of the subset of the one or more neighboring base stations.

Certain embodiments provide a computer-program storage apparatus for wireless communications comprising a memory device having a set of instructions stored thereon, the set of instructions being executable by one or more processors. The set of instructions generally includes instructions for transmitting a sector direction of a serving base station and one or more sector directions of one or more neighboring base stations, and instructions for receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates example operations that may be performed, for example, by a mobile station, for performing a handover to a co-located base station in accordance with certain embodiments set forth herein.

FIG. 4A illustrates example components capable of performing the operations of FIG. 4.

FIG. 5 illustrates a table defining a location-based services advertisement (LBS-ADV) message format in accordance with certain embodiments set forth herein.

FIG. 6 illustrates an example network topology in accordance with certain embodiments set forth herein.

FIG. 7 illustrates a table listing results of a mobile station determining if at least one neighbor base station is adjacent to a serving base station in accordance with certain embodiments set forth herein.

FIG. 8 illustrates example operations that may be performed, for example, by a mobile station, for performing a handover to at least one neighbor base station adjacent to the serving base station in accordance with certain embodiments set forth herein.

FIG. 8A illustrates example components capable of performing the operations of FIG. 8.

FIG. 9 illustrates example operations that may be performed, for example, by a serving base station, for transmitting location data of base stations to a mobile station in accordance with certain embodiments set forth herein.

FIG. 9A illustrates example components capable of performing the operations of FIG. 9.

FIG. 10 illustrates an example message exchange corresponding to the example operations shown in FIGS. 4, 8 and 9.

### DETAILED DESCRIPTION

Certain embodiments of the present disclosure provide methods and apparatus for improving performance and robustness of a handover procedure. For example, by handing over to a target base station (BS) that is co-located with a serving BS (i.e., a BS located in the same physical node as the serving BS), mobile station (MS) context transfers, handover preparation and downlink (DL) data continuity between the serving BS and the target BS may be simplified because the serving BS and the target BS are in the same physical node. Further, a location-based services advertisement (LBS-ADV) message may be enhanced to include sector center directions of the serving BS and neighboring BSs. Using this information, an MS may determine neighboring BSs that are adjacent to the serving BS and limit scanning operations and handovers to these adjacent BSs, thereby reducing the processing for those operations.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

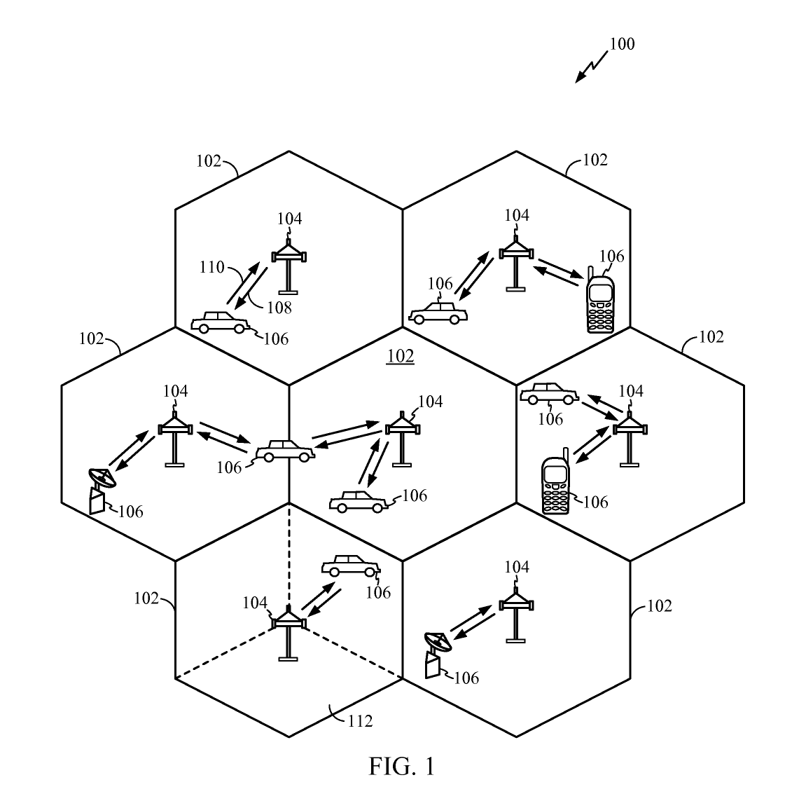

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

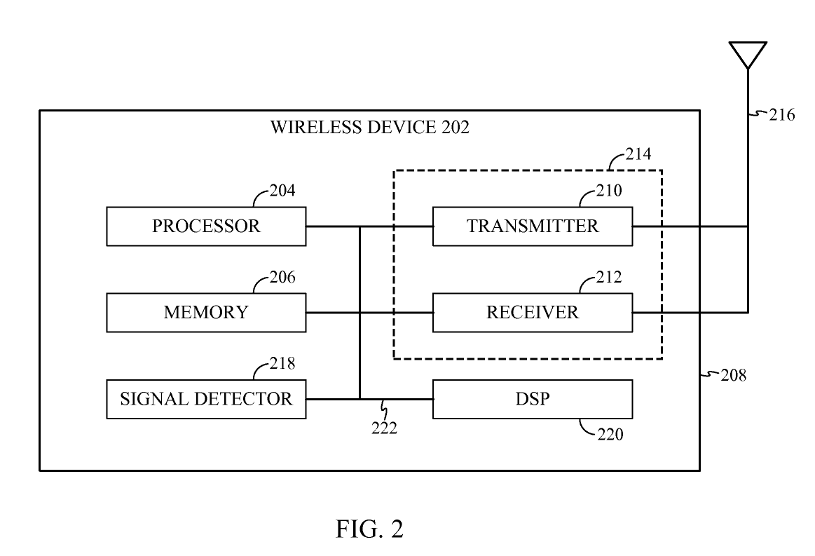

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

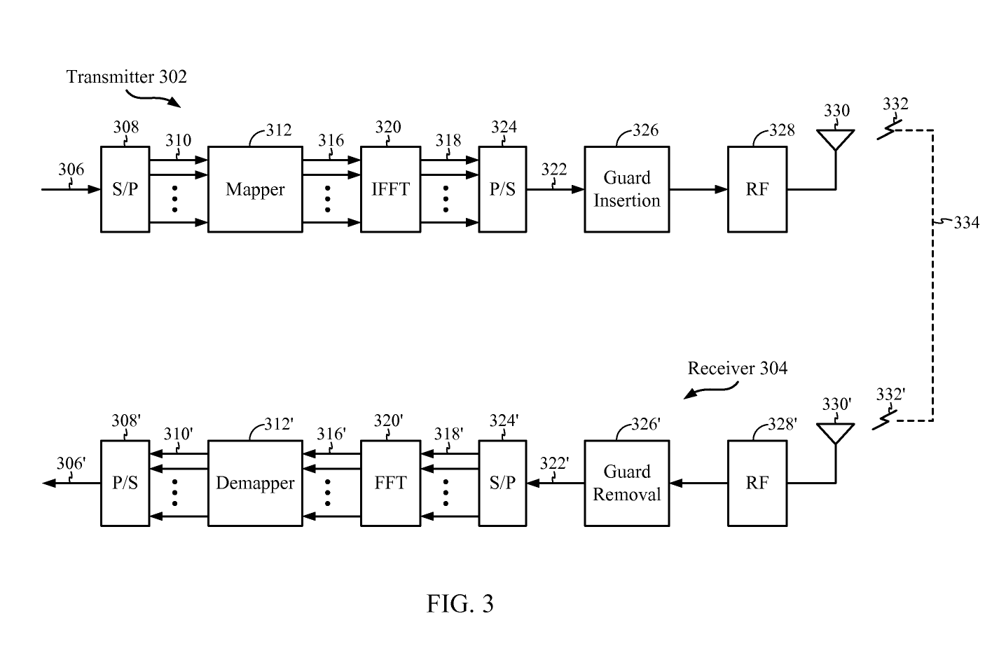

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp}, (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Selection of a Handover Base Station in Mobile WiMAX

Certain embodiments of the present disclosure may help improve performance and robustness of a handover procedure. For example, by handing over to a target base station (BS) that is co-located with a serving BS, mobile station (MS) context transfers, handover preparation and downlink (DL) data continuity between the serving BS and the target BS may be simplified because the serving BS and the target BS are in the same physical node. Further, a location-based services advertisement (LBS-ADV) message may be enhanced to include sector center directions of the serving BS and neighboring BSs. Using this information, an MS may determine neighboring BSs that are adjacent to the serving BS and limit scanning operations and handovers to these adjacent BSs, thereby reducing the processing for those operations.

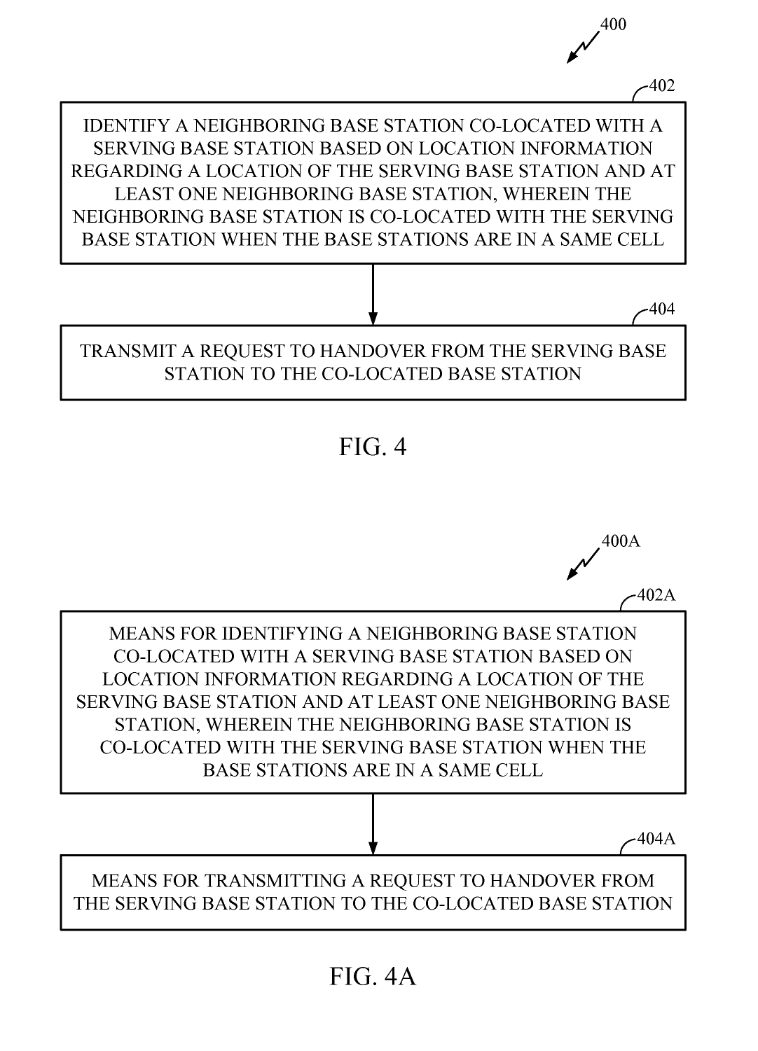

FIG. 4 illustrates example operations 400 that may be performed, for example, by an MS, for performing a handover to a co-located target BS in accordance with certain embodiments set forth herein. At 402, the MS may identify a neighboring BS co-located with a serving BS based on location information regarding a location of the serving BS and at least one neighboring BS. For certain embodiments, the location information may be received from the serving BS. When identifying a BS co-located with the serving BS (i.e., a BS located in the same physical node as the serving BS), the MS may use information received via the LBS-ADV message.

The LBS-ADV message may include information specifying the location of the serving BS and the at least one neighboring BS. For certain embodiments, the location may be an absolute position, i.e., latitude (in degrees), longitude (in degrees), and altitude (in meters). For certain embodiments, the location may be a relative position, i.e., distance north (or south) of the reference point (in meters), distance east (or west) of the reference point (in meters), and distance above (or below) the reference point (in meters).

Therefore, a BS co-located with the serving BS may be identified by comparing the locations of the serving BS and the at least one neighboring BS. For certain embodiments, if the at least one neighboring BS has the same absolute location (i.e., the same latitude, longitude and altitude) as the serving BS, the at least one neighboring BS may be identified as at least one BS co-located with the serving BS. For certain embodiments, if the at least one neighboring BS has the same relative location (i.e., the same distance north (or south) of a reference point, the same distance east (or west) of a reference point, and the same distance above (or below) a reference point) as the serving BS, the at least one neighboring BS may be identified as at least one BS co-located with the serving BS.

When detecting the neighboring BS co-located with the serving BS, the MS may first select the at least one neighboring BS having a carrier to interference-plus-noise ratio (CINR) or received signal strength indication (RSSI) that exceeds some absolute threshold or is better than the serving BS's CINR (or RSSI) by a relative margin. From this set, the MS may select the neighboring BS co-located with the serving BS. If more than one of the at least one neighboring BS are co-located with the serving BS, the MS may select the co-located BS having the highest CINR (or RSSI) as the neighboring BS.

At 404, the MS may transmit a request to handover from the serving BS to the neighboring BS co-located the serving BS. In the event that no co-located BSs are available for handoff, the MS may choose a BS from the at least one neighboring BS having the highest CINR (or RSSI).

For certain embodiments, an MS may initiate a handover to a neighboring BS that is adjacent to the serving BS. At least one adjacent BS may be determined by using a center direction of the sector of the serving BS and at least one neighboring BS. For certain embodiments, the respective center sector directions may be determined by the serving BS and transferred to the MS via the LBS-ADV message. Thus, the LBS-ADV may include information specifying the center direction of the sector (or segment) of the serving BS and the at least one neighboring BS.

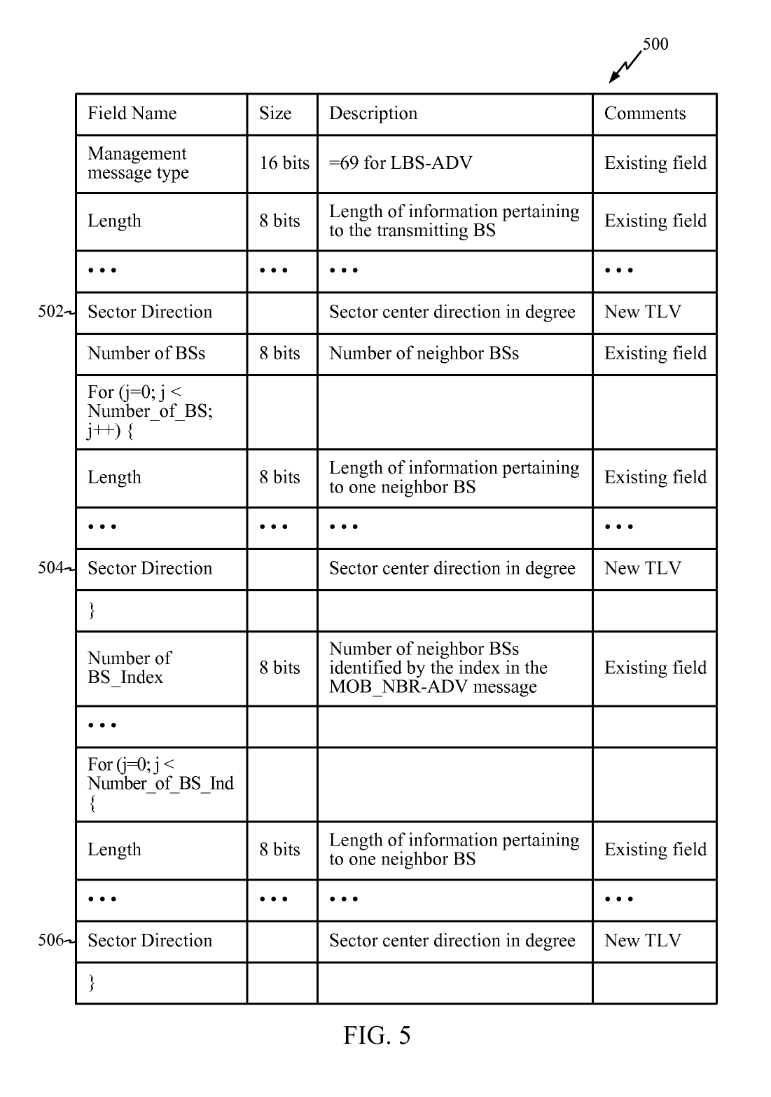

FIG. 5 shows a table 500 defining an LBS-ADV message format in accordance with certain embodiments set forth herein. As shown, a sector direction field 502 is specified for the serving BS, a section direction field 504 is specified for the at least one neighboring BS, and a sector direction field 506 is specified for each of the at least one neighboring BS identified by the index in a mobile neighbor advertisement (MOB_NBR-ADV) message. Each of the sector direction fields may be defined as a Type/Length/Value (TLV) element inside of the LBS-ADV message.

For certain embodiments, a sector direction TLV may be defined as having a length of one byte. Each sector direction TLV 502, 504, 506 may specify the number of degrees (e.g., 0° to 360°) a particular BS may be away from a reference direction (e.g., east, west, north or south). For certain embodiments, a sector direction value of 0x00 may be equivalent to the reference direction. A sector direction value of 0xFF may indicate that the particular BS is in an omni-directional cell or a single-sector cell.

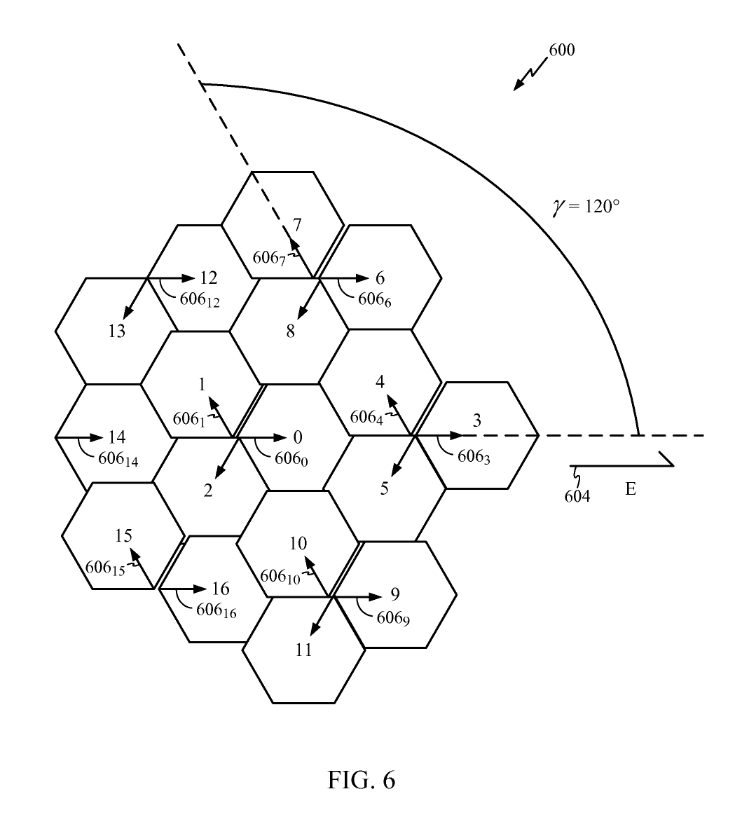

FIG. 6 shows an example network topology 600 in accordance with certain embodiments set forth herein. As shown, the topology 600 may include a serving BS (BS0) and 16 neighboring BSs (BS1 . . . BS16). The reference direction 604 may be shown as being east. Therefore, each BS having a sector center direction (which is indicated by vectors 606) equivalent to the reference direction 604, may have a sector center direction angle of 0°. As shown, BS0, BS3, BS6, BS9, BS12, BS14 and BS16 each have vectors (606₀, 606₃, 606₆, 606₉, 606₁₂, 606₁₄ and 606₁₆, respectively) pointed in the same direction as the reference direction 604. Therefore, the sector center direction for these BSs may be 0°. Contrast this with the sector center directions of BS1, BS4, BS7, BS10 and BS15. Here, their respective vectors (606₁, 606₄, 606₇, 606₁₀ and 606₁₅) may be 120° (indicated as γ in FIG. 6) relative to the reference direction 604.

Each BS may also have co-located BSs. For example, BS0 may be co-located with BS1 and BS2, BS3 may be co-located with BS4 and BS5, BS6 may be co-located with BS7 and BS8, etc. An MS may scan or handover to any of the 16 BSs neighboring the BS0. However, an MS may limit a scan operation or handover to neighboring BSs co-located with BS0 (i.e., BS1 and BS2), as previously discussed. Further, using the sector directions of the BSs, an MS may limit a scan operation or handover to neighboring BSs adjacent to BS0 (i.e., BS4, BS5, BS8, BS10), thereby reducing the processing for those operations.

To determine the at least one neighboring BS adjacent to the serving BS, the MS may perform the following operations. First, using the absolute (or relative) location (received via the LBS-ADV message) of the serving BS and the at least one neighboring BSs, the MS may translate the location of a respective BS to a two-dimensional coordinate. For example, if using the absolute position, the MS may use the following formula:

(x,y)=(R*cos(latitude)*longitude*π/180, R*latitude*m/180),

where R is the radius of the earth, i.e., 6,378 km.

If using the relative position, the MS may simply use the distance east (or west) of the reference point as the x coordinate and use the distance north (or south) of the reference point as they coordinate:

(x,y)=(distance east of reference point, distance north of reference point)

The MS may then calculate a distance d between the serving BS and the at least one neighbor BS using the following formula:

d=\sqrt{(x−x₀)²+(y−y₀)²},

where (x,y) is the coordinate of the at least one neighbor BS and (x₀,y₀) is the coordinate of the serving BS.

Next, the MS may calculate the normalized vector from the serving BS to the at least one neighbor BS using the following formula:

(u, v)=((x, y)−(x₀, y₀))/d

Using the normalized vector (u, v), the MS may then calculate a relative location direction β of the normalized vector of the at least one neighbor BS location referenced by the serving BS:

(u, v)=(cos(β), sin(β))

Using the calculated distance d between the serving BS and the at least one neighboring BS, the calculated relative location direction β of the at least one neighbor BS, a sector direction angle α of the serving BS (which may be received via the LBS-ADV message), and a sector direction angle γ of the at least one neighboring BS (which may also be received via the LBS-ADV message), the MS may be able to determine which of the at least one neighboring BS is adjacent to the serving BS (not including the co-located BSs).

For certain embodiments, the MS may determine if the at least one neighboring BS is adjacent to a serving BS if the following criteria are all true: (1) the distance between the serving BS and the at least one neighbor BS is non-zero and less than some threshold (e.g., d<H, where H is the threshold), (2) the serving BS sector direction angle α and the at least one neighbor BS's relative location direction β differs by less than or equal to a certain margin (e.g., 60 degrees: |α−β|≦60), and (3) the at least one neighbor BS's sector direction angle γ points to an opposite direction of its relative location direction β by less than or equal to a certain margin (e.g., 60 degrees: |γ−[(β+180)mod360]|≦60).

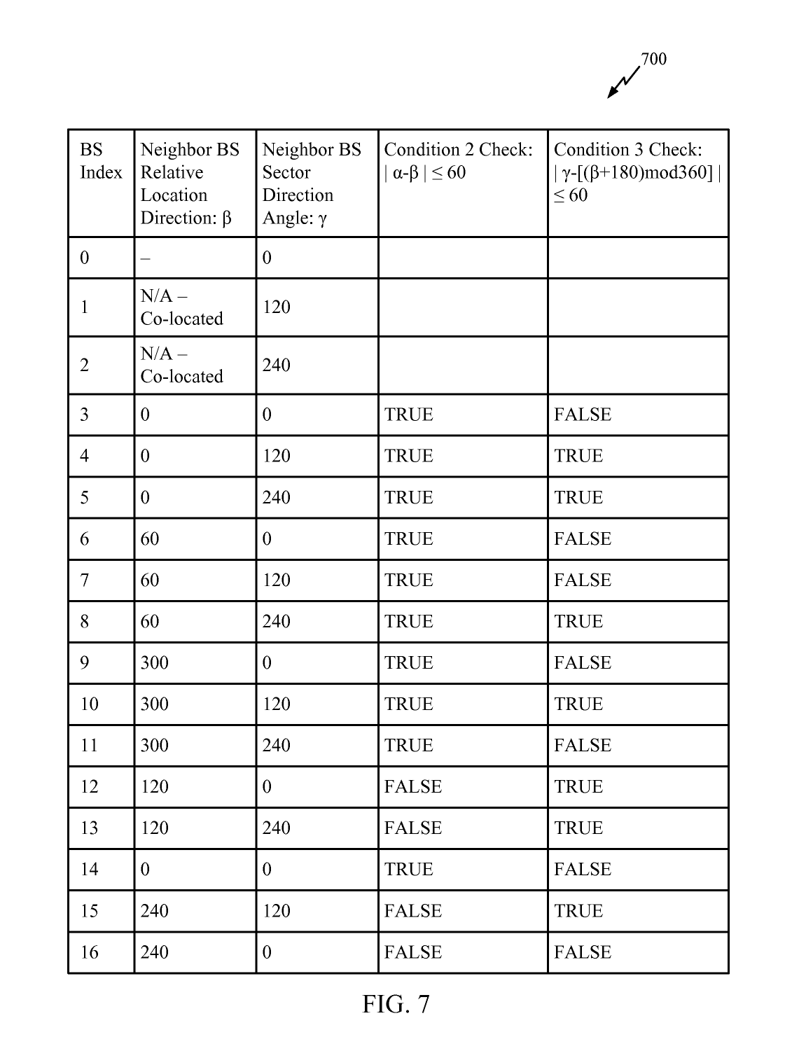

FIG. 7 shows a table 700 listing results of an MS applying the criteria to determine if at least one neighbor BS is adjacent to a serving BS in accordance with certain embodiments set forth herein. In the table 700, the criteria are applied to the BS topology illustrated in FIG. 6. As stated earlier, the reference direction 604 in FIG. 6 is east, and the sector direction angle α of the serving BS is 0°.

As shown in table 700, the criteria may be met for BS4, BS5, BS8 and BS10. It is noted that because BS1 and BS2 may be determined to be co-located with BS0, the MS may not need to apply the criteria to determine if those BS1 and BS2 are adjacent to the serving BS (BS0). Thus, the MS may choose BS1, BS2, BS4, BS5, BS8 and BS10 for scanning operations or handover.

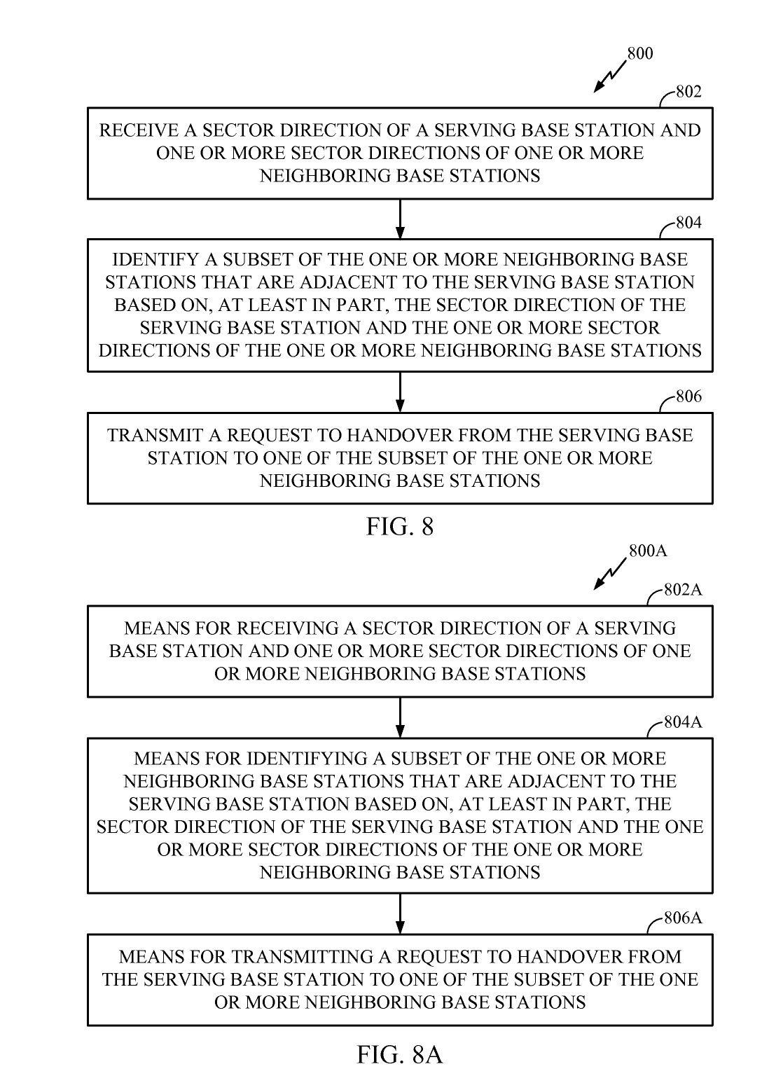

FIG. 8 illustrates example operations 800 that may be performed, for example, by an MS, for performing a handover to at least one neighbor BS adjacent to a serving BS in accordance with certain embodiments set forth herein. At step 802, the MS may receive a sector direction of the serving base station and the one or more neighboring base stations. At step 804, the MS may identify a subset of the one or more neighboring base stations that are adjacent to the serving base station based on, at least in part, the sector direction of the serving base station and the one or more neighboring base stations. At step 806, the MS may transmit a request to handover from the serving base station to one of the subset of the one or more neighboring base stations.

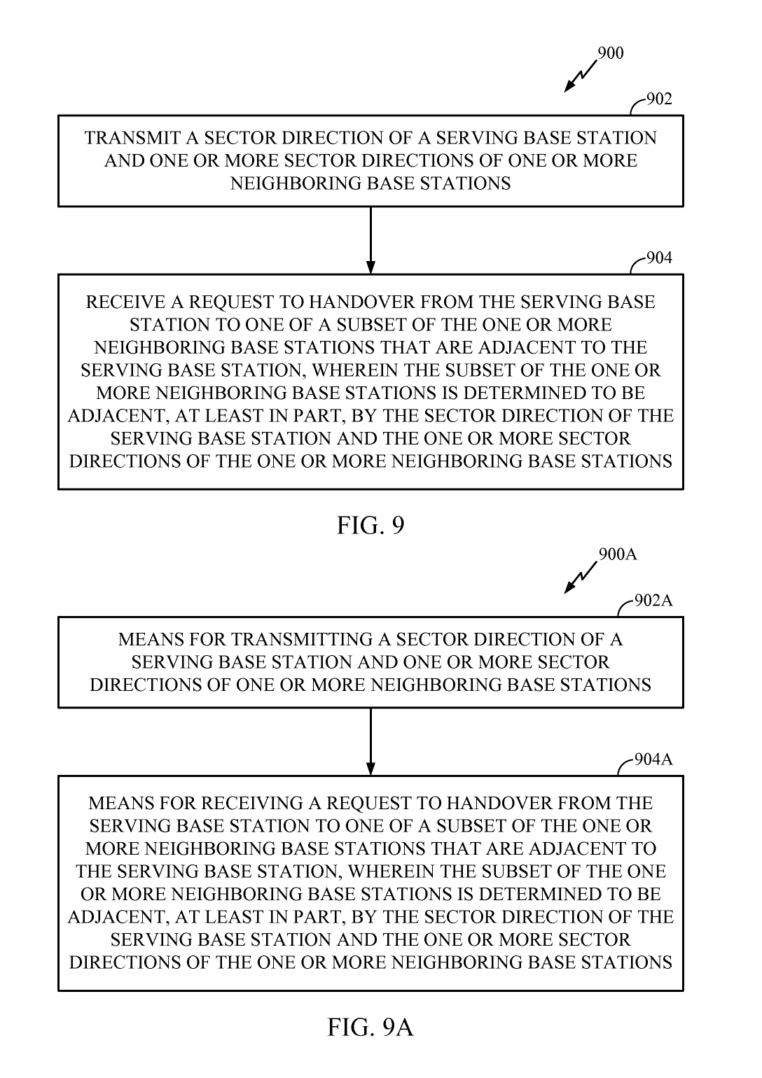

FIG. 9 illustrates example operations 900 that may be performed, for example, by a serving BS, for transmitting location data of BSs to an MS in accordance with certain embodiments set forth herein. At step 902, the serving BS may transmit a sector direction of a serving BS and one or more neighboring BSs to a MS. At step 904, the serving BS may receive a request to handover from the serving BS to one of a subset of the one or more neighboring BSs that are adjacent to the serving BS. The subset of the one or more neighboring BSs may be determined to be adjacent, at least in part, by the sector direction of the serving base station and the one or more neighboring base stations.

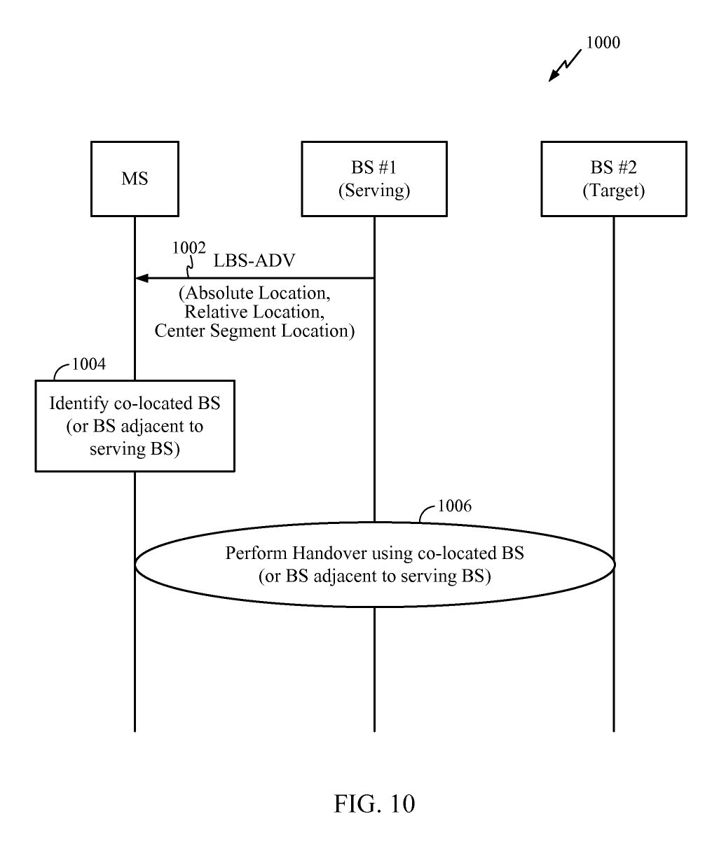

FIG. 10 illustrates an example message exchange 1000 corresponding to the example operations shown in FIGS. 4, 8 and 9 in accordance with certain embodiments set forth herein. At 1002, the serving BS may send an LBS-ADV message to an MS. The LBS-ADV message may contain location information such as the absolute and relative locations of the serving BS and the at least one neighboring BSs. For certain embodiments, the LBS-ADV may also contain the sector center directions of the serving BS and the at least one neighboring BSs. At 1004, using the location information from the LBS-ADV message, the MS may determine which of the at least one neighboring BS are co-located with the serving BS. For certain embodiments, the MS may determine which of the at least one neighboring BS are adjacent to the serving BS. At step 1006, a handover procedure is initiated with the at least one co-located (or adjacent) neighboring BS being designated as the target BS.

The various operations of methods described above may be performed by various hardware and/or software component(s) and/or module(s) corresponding to means-plus-function blocks illustrated in the figures. Generally, where there are methods illustrated in figures having corresponding counterpart means-plus-function figures, the operation blocks correspond to means-plus-function blocks with similar numbering. For example, operations 400 illustrated in FIG. 4 corresponds to means-plus-function blocks 400A illustrated in FIG. 4A, FIG. 8 corresponds to means-plus-function blocks 800A illustrated in FIG. 8A, and FIG. 9 corresponds to means-plus-function blocks 900A illustrated in FIG. 9A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules, circuits or other type of hardware logic described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium, or memory device. A storage media may be any available media that can be accessed by a computer. By way of example, and not limitation, such computer-readable media or memory device can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium, for example, from one storage medium to another storage medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications, comprising:
identifying a neighboring base station co-located with a serving base station based on location information regarding a location of the serving base station and at least one neighboring base station, wherein the neighboring base station is co-located with the serving base station when the base stations are in a same cell; and
transmitting a request to handover from the serving base station to the co-located base station.

2. The method of claim 1, wherein the location information regarding the location of the serving base station and at least one neighboring base station is received from the serving base station.

3. The method of claim 1, wherein the location information contains at least one of a relative location and an absolute location of the serving base station and the at least one neighboring base station.

4. A method for wireless communications, comprising:
receiving a sector direction of a serving base station and one or more sector directions of one or more neighboring base stations;
identifying a subset of the one or more neighboring base stations that are adjacent to the serving base station based on, at least in part, the sector direction of the serving base station and the one or more sector directions of the one or more neighboring base stations; and
transmitting a request to handover from the serving base station to one of the subset of the one or more neighboring base stations.

5. The method of claim 4, wherein the request is transmitted if a distance between the serving base station and the one of the subset of the one or more neighboring base stations is less than or equal to a threshold.

6. The method of claim 5, wherein the request is transmitted if the sector direction of the serving base station and a relative location direction of the one of the subset of the one or more neighboring base stations is less than or equal to a threshold, wherein the relative location direction is referenced by the serving base station.

7. The method of claim 6, wherein the request is transmitted if the sector direction of the one of the subset of the one or more neighboring base stations points to an opposite direction of the relative location direction by a certain threshold.

8. A method for wireless communications, comprising:
transmitting a sector direction of a serving base station and one or more sector directions of one or more neighboring base stations; and
receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

9. The method of claim 8, wherein the request is received if the sector direction of the serving base station and a relative location direction of the one of the subset of the one or more neighboring base stations is less than or equal to a threshold, wherein the relative location direction is referenced by the serving base station.

10. The method of claim 8, wherein the request is received if the sector direction of the one of the subset of the one or more neighboring base stations points to an opposite direction of the relative location direction by a certain threshold.

11. An apparatus for wireless communications, comprising:
logic for identifying a neighboring base station co-located with a serving base station based on location information regarding a location of the serving base station and at least one neighboring base station, wherein the neighboring base station is co-located with the serving base station when the base stations are in a same cell; and
logic for transmitting a request to handover from the serving base station to the co-located base station.

12. The apparatus of claim 11, wherein the location information regarding the location of the serving base station and at least one neighboring base station is received from the serving base station.

13. The apparatus of claim 11, wherein the location information contains at least one of a relative location and an absolute location of the serving base station and the at least one neighboring base station.

14. An apparatus for wireless communications, comprising:
logic for receiving a sector direction of a serving base station and one or more sector directions of one or more neighboring base stations;
logic for identifying a subset of the one or more neighboring base stations that are adjacent to the serving base station based on, at least in part, the sector direction of the serving base station and the one or more sector directions of the one or more neighboring base stations; and
logic for transmitting a request to handover from the serving base station to one of the subset of the one or more neighboring base stations.

15. The apparatus of claim 14, wherein the request is transmitted if a distance between the serving base station and the one of the subset of the one or more neighboring base stations is less than or equal to a threshold.

16. The apparatus of claim 15, wherein the request is transmitted if the sector direction of the serving base station and a relative location direction of the one of the subset of the one or more neighboring base stations is less than or equal to a threshold, wherein the relative location direction is referenced by the serving base station.

17. The apparatus of claim 16, wherein the request is transmitted if the sector direction of the one of the subset of the one or more neighboring base stations points to an opposite direction of the relative location direction by a certain threshold.

18. An apparatus for wireless communications, comprising:
logic for transmitting a sector direction of a serving base station and one or more sector directions of one or more neighboring base stations; and
logic for receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

19. The apparatus of claim 18, wherein the request is received if the sector direction of the serving base station and a relative location direction of the one of the subset of the one or more neighboring base stations is less than or equal to a threshold, wherein the relative location direction is referenced by the serving base station.

20. The apparatus of claim 18, wherein the request is received if the sector direction of the one of the subset of the one or more neighboring base stations points to an opposite direction of the relative location direction by a certain threshold.

21. An apparatus for wireless communications, comprising:
means for identifying a neighboring base station co-located with a serving base station based on location information regarding a location of the serving base station and at least one neighboring base station, wherein the neighboring base station is co-located with the serving base station when the base stations are in a same cell; and
means for transmitting a request to handover from the serving base station to the co-located base station.

22. The apparatus of claim 21, wherein the location information regarding the location of the serving base station and at least one neighboring base station is received from the serving base station.

23. The apparatus of claim 21, wherein the location information contains at least one of a relative location and an absolute location of the serving base station and the at least one neighboring base station.

24. An apparatus for wireless communications, comprising:
means for receiving a sector direction of a serving base station and one or more sector directions of one or more neighboring base stations;
means for identifying a subset of the one or more neighboring base stations that are adjacent to the serving base station based on, at least in part, the sector direction of the serving base station and the one or more sector directions of the one or more neighboring base stations; and
means for transmitting a request to handover from the serving base station to one of the subset of the one or more neighboring base stations.

25. The apparatus of claim 24, wherein the request is transmitted if a distance between the serving base station and the one of the subset of the one or more neighboring base stations is less than or equal to a threshold.

26. The apparatus of claim 25, wherein the request is transmitted if the sector direction of the serving base station and a relative location direction of the one of the subset of the one or more neighboring base stations is less than or equal to a threshold, wherein the relative location direction is referenced by the serving base station.

27. The apparatus of claim 26, wherein the request is transmitted if the sector direction of the one of the subset of the one or more neighboring base stations points to an opposite direction of the relative location direction by a certain threshold.

28. An apparatus for wireless communications, comprising:
means for transmitting a sector direction of a serving base station and one or more sector directions of one or more neighboring base stations; and
means for receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

29. The apparatus of claim 28, wherein the request is received if the sector direction of the serving base station and a relative location direction of the one of the subset of the one or more neighboring base stations is less than or equal to a threshold, wherein the relative location direction is referenced by the serving base station.

30. The apparatus of claim 28, wherein the request is received if the sector direction of the one of the subset of the one or more neighboring base stations points to an opposite direction of the relative location direction by a certain threshold.

31. A computer-program storage apparatus for wireless communications comprising a memory device having a set of instructions stored thereon, the set of instructions being executable by one or more processors and the set of instructions comprising:
instructions for identifying a neighboring base station co-located with a serving base station based on location information regarding a location of the serving base station and at least one neighboring base station, wherein the neighboring base station is co-located with the serving base station when the base stations are in a same cell; and
instructions for transmitting a request to handover from the serving base station to the co-located base station.

32. The computer-program storage apparatus of claim 31, wherein the location information regarding the location of the serving base station and at least one neighboring base station is received from the serving base station.

33. The computer-program storage apparatus of claim 31, wherein the location information contains at least one of a relative location and an absolute location of the serving base station and the at least one neighboring base station.

34. A computer-program storage apparatus for wireless communications comprising a memory device having a set of instructions stored thereon, the set of instructions being executable by one or more processors and the set of instructions comprising:
instructions for receiving a sector direction of a serving base station and one or more sector directions of one or more neighboring base stations;
instructions for identifying a subset of the one or more neighboring base stations that are adjacent to the serving base station based on, at least in part, the sector direction of the serving base station and the one or more sector directions of the one or more neighboring base stations; and
instructions for transmitting a request to handover from the serving base station to one of the subset of the one or more neighboring base stations.

35. The computer-program storage apparatus of claim 34, wherein the request is transmitted if a distance between the serving base station and the one of the subset of the one or more neighboring base stations is less than or equal to a threshold.

36. The computer-program storage apparatus of claim 35, wherein the request is transmitted if the sector direction of the serving base station and a relative location direction of the one of the subset of the one or more neighboring base stations is less than or equal to a threshold, wherein the relative location direction is referenced by the serving base station.

37. The computer-program storage apparatus of claim 36, wherein the request is transmitted if the sector direction of the one of the subset of the one or more neighboring base stations points to an opposite direction of the relative location direction by a certain threshold.

38. A computer-program storage apparatus for wireless communications comprising a memory device having a set of instructions stored thereon, the set of instructions being executable by one or more processors and the set of instructions comprising:
instructions for transmitting a sector direction of a serving base station and one or more sector directions of one or more neighboring base stations; and
instructions for receiving a request to handover from the serving base station to one of a subset of the one or more neighboring base stations that are adjacent to the serving base station, wherein the subset of the one or more neighboring base stations is determined to be adjacent, at least in part, by the sector direction of the serving base station and the one or more sector directions of the one or more neighboring base stations.

39. The computer-program storage apparatus of claim 38, wherein the request is received if the sector direction of the serving base station and a relative location direction of the one of the subset of the one or more neighboring base stations is less than or equal to a threshold, wherein the relative location direction is referenced by the serving base station.

40. The computer-program storage apparatus of claim 38, wherein the request is received if the sector direction of the one of the subset of the one or more neighboring base stations points to an opposite direction of the relative location direction by a certain threshold.
